(19) United States
(12) Patent Application Publication
(10) Pub. No.: US 2026/0221121 A1
(43) Pub. Date: Jul. 30, 2026

(54) Modular Stringed Instrument

(71) Applicant: Stephen Monte Kluthe, Fallbrook, CA (US)

(72) Inventor: Stephen Monte Kluthe, Fallbrook, CA (US)

(21) Appl. No.: 19/034,520

(22) Filed: Jan. 22, 2025

(51) Int. Cl. G10D 1/08; G10D 3/04; G10D 3/095; G10D 3/12; G10H 3/18

(52) U.S. Cl. CPC G10D 1/085; G10D 3/04; G10D 3/095; G10D 3/12; G10H 3/181; G10H 2220/461

(57) ABSTRACT

A modular stringed instrument such as a guitar having a plurality of removable parts. In various embodiment, the neck, body, pickups, and bridge may be quickly and easily removed and replaced. This enables the guitar to be customized for a variety of musical sounds effects styles and tastes. In one embodiment, pickups are mounted in a pickup carriage that is easily slid off the guitar body without the necessity of removing the strings. In another embodiment the neck and bridge may be removed without the use of tools. The modular stringed instrument guitar may be constructed using a 3D printer and may be of constructed to be an electric or an acoustic stringed instrument.

### FIELD OF INVENTION

The present invention relates to musical instruments and particularly to stringed instruments such as guitars with modular construction.

### BACKGROUND

This section is intended to provide a background or context to the disclosed embodiments that are recited in the claims. The description herein may include concepts that could be pursued but are not necessarily ones that have been previously conceived or pursued. Therefore, unless otherwise indicated herein, what is described in this section is not prior art to the description and claims in this application and is not admitted to be prior art by inclusion in this section.

There exists a wide variety of types of stringed instrument, such as guitars, including acoustic, electric, hollow body, solid body, headless, etc. Moreover, guitars of a given type can be constructed in a variety of configurations, with varied sizes, bridges, pickups, heads, body styles, electronic features, etc. These different configurations offer a guitarist the option of selecting a guitar with the features, advantages and sound that best suits their musical tastes, moods, and musical genre. As a result of the large variety of guitar styles and configurations, guitarists selecting a guitar are faced with a daunting array of choices. It may take a guitarist a long time to try out the different guitars until the desired combination of style and features is found. Because of this variety, many guitarists purchase at great expense multiple guitars to suit different musical styles and individual tastes and moods.

### BRIEF DESCRIPTION OF THE DRAWINGS

FIG. 1 illustrates perspective view of a modular guitar that can be used for implementing various disclosed embodiments.

FIG. 2 illustrates a top back right view of a center body of modular guitar that can be used for implementing various disclosed embodiments.

FIG. 3 illustrates a top back left view of a center body of modular guitar that can be used for implementing various disclosed embodiments.

FIG. 4 illustrates a top front right view of a center body of modular guitar that can be used for implementing various disclosed embodiments.

FIG. 5 illustrates a bottom front left view a center body of modular guitar that can be used for implementing various disclosed embodiments.

FIG. 6 illustrates a bottom back right view of a center body of modular guitar that can be used for implementing various disclosed embodiments.

FIG. 7 illustrates a bottom front right view of a center body of modular guitar that can be used for implementing various disclosed embodiments.

FIG. 8 illustrates a top back left view of a single pickup carriage for a modular guitar that can be used for implementing various disclosed embodiments.

FIG. 9 illustrates a top back left view of a humbucker pickup carriage for a modular guitar that can be used for implementing various disclosed embodiments.

FIG. 10 illustrates a bottom back right view of a humbucker pickup carriage for a modular guitar that can be used for implementing various disclosed embodiments.

FIG. 11 illustrates a bottom back left view of a humbucker pickup carriage for a modular guitar that can be used for implementing various disclosed embodiments.

FIG. 12 illustrates a top back left view of an assembly including a center body, pickup carriages and bridge mount for a modular guitar that can be used for implementing various disclosed embodiments.

FIG. 13 illustrates a top back left view of an assembly including a center body, pickup carriages and bridge mount for a modular guitar that can be used for implementing various disclosed embodiments.

FIG. 14 illustrates a bottom front right view of an assembly including a center body, pickup carriages and bridge mount for a modular guitar that can be used for implementing various disclosed embodiments.

FIG. 15 illustrates a top front left view of an assembly including a center body, pickup carriages and bridge mount for a modular guitar that can be used for implementing various disclosed embodiments.

FIG. 16 illustrates a top front left view of a bridge mount for a modular guitar that can be used for implementing various disclosed embodiments.

FIG. 17 illustrates a top back left view of a bridge mount for a modular guitar that can be used for implementing various disclosed embodiments.

FIG. 18 illustrates a left view of a neck block for a modular guitar that can be used for implementing various disclosed embodiments.

FIG. 19 illustrates a top back right view of a neck block for a modular guitar that can be used for implementing various disclosed embodiments.

FIG. 20 illustrates a bottom back left view of a neck block for a modular guitar that can be used for implementing various disclosed embodiments.

FIG. 21 illustrates a bottom back right view of a left body for a modular guitar that can be used for implementing various disclosed embodiments.

FIG. 22 illustrates a bottom back left view of a left body for a modular guitar that can be used for implementing various disclosed embodiments.

FIG. 23 illustrates a top back left view of a left body for a modular guitar that can be used for implementing various disclosed embodiments.

FIG. 24 illustrates a bottom front left view of a full left body for a modular guitar that can be used for implementing various disclosed embodiments.

FIG. 25 illustrates a top back left view of left cover plate for a modular guitar that can be used for implementing various disclosed embodiments.

FIG. 26 illustrates a bottom front left view of a right cover plate for a modular guitar that can be used for implementing various disclosed embodiments.

FIG. 27 illustrates a top back left view of a right cover plate for a modular guitar that can be used for implementing various disclosed embodiments.

FIG. 28 illustrates a bottom front left view of a full right body for a modular guitar that can be used for implementing various disclosed embodiments.

FIG. 29 illustrates a top back left view of a full right body for a modular guitar that can be used for implementing various disclosed embodiments.

FIG. 30 illustrates a top right front view of a full left body for a modular guitar that can be used for implementing various disclosed embodiments.

FIG. 31 illustrates a bottom back left view of a right plate for a modular guitar that can be used for implementing various disclosed embodiments.

FIG. 32 illustrates a top back left view of a right plate for a modular guitar that can be used for implementing various disclosed embodiments.

FIG. 33 illustrates a bottom back right view of an assembly including center body, neck block, left and right bodies, and bridge mount for a modular guitar that can be used for implementing various disclosed embodiments.

FIG. 34 illustrates a top back left view of an assembly including center body, neck block, left and right bodies, pickup carriages, and bridge mount for a modular guitar that can be used for implementing various disclosed embodiments.

FIG. 35 illustrates a top front left view of an assembly including center body, neck block, left and right bodies, pickup carriages, and bridge mount for a modular guitar that can be used for implementing various disclosed embodiments.

FIG. 36 illustrates a top back right view of an assembly including center body, neck block, left and right bodies, pickup carriages, and bridge mount for a modular guitar that can be used for implementing various disclosed embodiments.

FIG. 37 illustrates a top back left view of an assembly including center body, neck block, left and right bodies, pickup carriages, and bridge mount for a modular guitar that can be used for implementing various disclosed embodiments.

FIG. 38 illustrates a top front right view of left body for a modular guitar that can be used for implementing various disclosed embodiments.

FIG. 39 illustrates a bottom right front view of a left plate for a modular guitar that can be used for implementing various disclosed embodiments.

### SUMMARY OF THE INVENTION

This section is intended to provide a summary of certain exemplary embodiments and is not intended to limit the scope of the embodiments that are disclosed in this application.

In one embodiment a modular stringed instrument including a body unit having front face with at least one pickup cavity disposed therein and a bridge unit attached to the guitar body. A neck unit is connected at a first end to the instrument body and having a head at the opposite end. A plurality of strings are attached to the head at one end to the bridge unit end. An electronic pickup carriage holding a pickup is removably attached to the body unit and configured to fit into the pickup cavity, wherein the body unit face is configured to enable the pickup carriage to slide laterally in a motion parallel to the body unit front face when removing the pickup carriage from the body unit, whereby the exchange of one pickup for another pickup is facilitated.

In another embodiment a modular stringed musical instrument comprises a center body having front face with at least one pickup cavity disposed therein and a bridge attached to the center body. A neck is connected at a first end to the center body and having a head at a second end. A plurality of strings are provided wherein each string being attached to the head at one end to the bridge at the other end. A bridge mount is removably attached to the center body, wherein and the bridge is attached to the bridge mount using fasteners. An angled appendage protrudes from the center body where it meets the bridge mount. The bridge mount has an angled cavity configured to receive the angled appendage in the center body, wherein the tension of the strings pulls the bridge mount to the center body such that when the strings are loosened, the bridge mount can be removed. As a result, fasteners attaching the bridge mount to the center body are not necessary and tools are not needed to remove the bridge.

These and other advantages and features of disclosed embodiments, together with the organization and manner of operation thereof, will become apparent from the following detailed description when taken in conjunction with the accompanying drawings.

### DETAILED DESCRIPTION OF CERTAIN EMBODIMENTS

In the following description, for purposes of explanation and not limitation, details and descriptions are set forth in order to provide a thorough understanding of the disclosed embodiments. However, it will be apparent to those skilled in the art that the present invention may be practiced in other embodiments that depart from these details and descriptions.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

The disclosed embodiments of a modular guitar with be referred to herein as a “modular guitar.” The modular guitar enables a single guitar to be easily modified into a variety of configurations. The disclosed embodiments include a modular guitar with easily replaceable modules including the body, neck, head, bridge, and electronic modules. As a result, a single guitar offers a large number of combinations of these components. The modular guitar has many advantages. It is easy for a musician to try out different configurations, to see how they sound and play without the need for acquiring different guitars, or trying out different guitars at a retail outlet. Since different components can be switched out in seconds without tools, a guitarist is able quicky try out dozens of different guitar configurations in minutes. To try out dozens of different guitar configurations in a conventional manner would likely take hours. In fact, the variety of configurations possible with the disclosed modular guitar, would not likely be available in even the largest guitar store, so that the process would take multiple days. This affords the musician to try out a larger number of different configurations than they could in the convention manner. This increases the likelihood of the guitarist finding the exact combination of features that suits the particular sound that they are seeking. In one application, retail establishments make the modular guitar available to customers so that they more easily try out many different configurations and components in the store before making a purchase.

Another advantage with the modular guitar is that once the guitarist has selected a particular configuration, it can be easily modified to accommodate different musical styles or moods. Thus, instead of having to own multiple guitars for this purpose, a single guitar can have one or more modules switched to accommodate the different musical style or different song. It would be even possible to change components of the guitar in the middle of a song. This results in a huge cost savings as compared to the cost of owning several different guitars.

Another advantage with the modular guitar is that it may be easily disassembled for storage and transport. This enables the guitar to be contained in a smaller package than a conventional guitar. For example, the modular guitar may be transported in a package that conforms to the carry-on luggage dimension requirements of airlines.

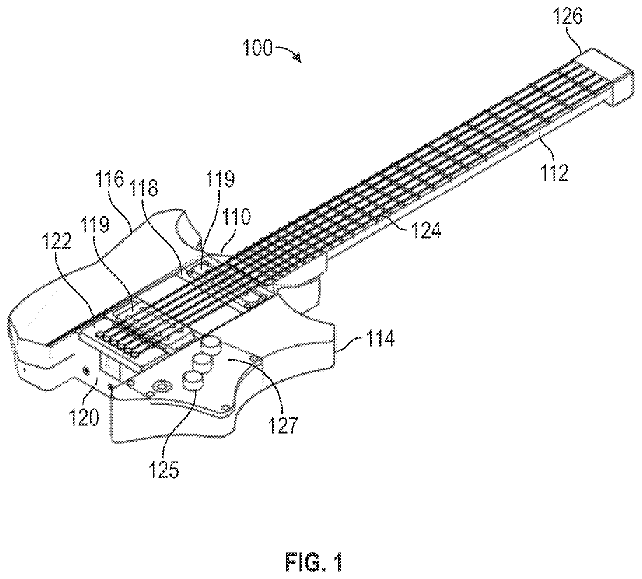

FIG. 1 shows a modular guitar 100 according to an exemplary embodiment. The modular guitar 100 includes a center body 110, a removable neck 112, a removable left body 114, a removable right body 116, one or more removable pickup carriages 118 and a removable bridge mount 120. A bridge 122 is attached to the bridge mount 120 and retains one end of the guitar strings 124. The other ends of the guitar strings are retained at the neck head 126. Note that the embodiment shown is a headless guitar where the strings are tuned at the bridge and not at the head end. Also shown in FIG. 1 is the top plate 127 and adjusting knobs 125.

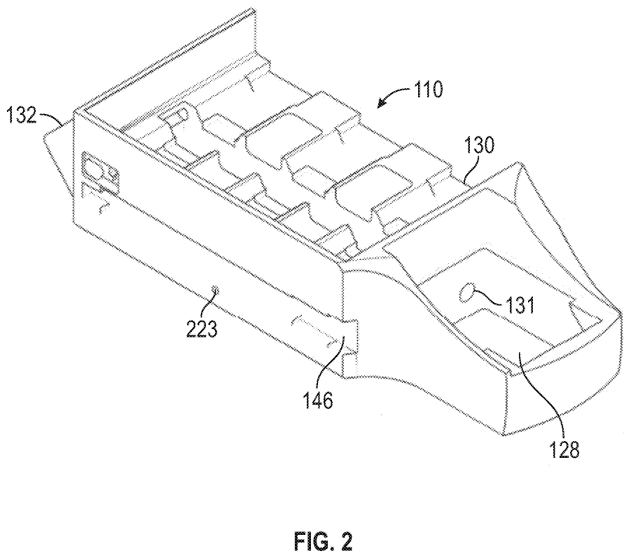

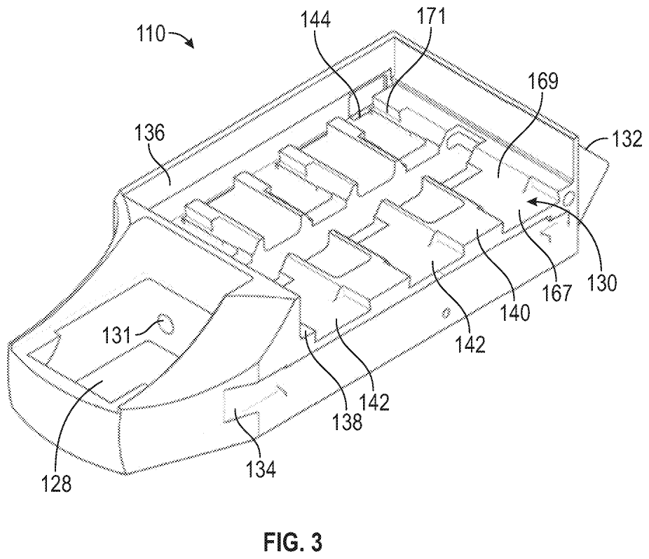

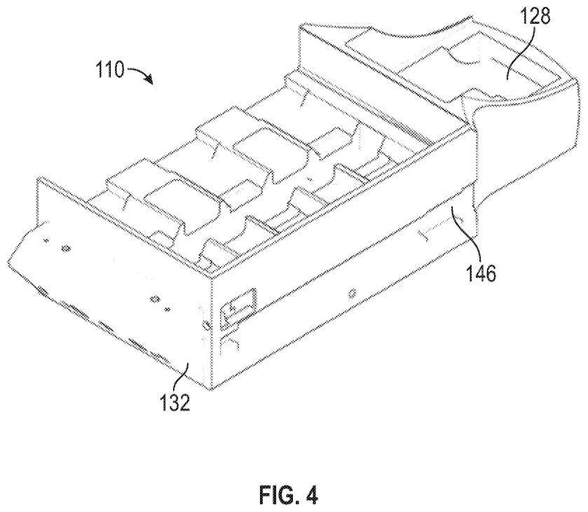

FIGS. 2-7 show various views of the center body 110. FIG. 2 shows a top back right side view of the center body 110, which includes a neck attachment opening 128, a pickup cavity 130, and a bridge mount appendage 132. A pair of openings 131 are provided to permit optional carbon fiber rods (not shown) to be inserted into the center body 110. The carbon fiber rods would contribute to tuning stability and would be inserted from the front end of the center body and extend substantially throughout the length of the center body 110. FIG. 3 shows a top back left view of the center body 110. In this example, pickup cavity 130 is configured to contain between one and three pickup carriages (described below). The pickup cavity 130 has a wall 136 on one side and an open side 138 opposite the wall 136. The pickup cavity 130 includes a bottom surface 140 and a plurality of slides 142. The slides 142 have a dove-tail configuration that complements the shape of the bottom surface of the pick-up carriages (described below). The slides 142 insure that the pickup carriages are correctly aligned and do not move after installation. The center body 110 also has a cable channel 144 which is configured to receive electrical cables (not shown) that are connected to the pickups 119 at one end and to the electronics module (described below). FIG. 3 also shows a dovetail slide 134 which is used to attach the right guitar body as described below. The slides 142 include three dovetails sections a larger one 167, a middle sized one 169 and a narrow one 172, which insure that the pickup carriage it does not move and is aligned. FIG. 4 shows a top front right view of the center body 110.

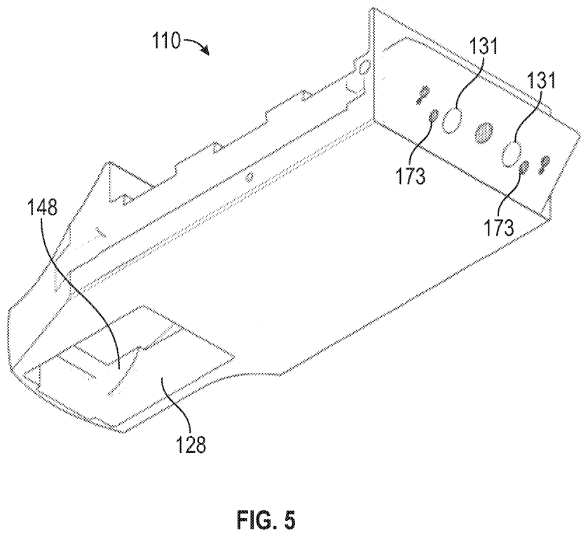

FIG. 5 shows a bottom front left view of the center body 110. In this view of the neck attachment opening 128, a curved slide 148 is shown, which is used to attach the neck block 188 as described below. Another curved slide 148 (not shown) is on an opposite side of the neck attachment opening 128.

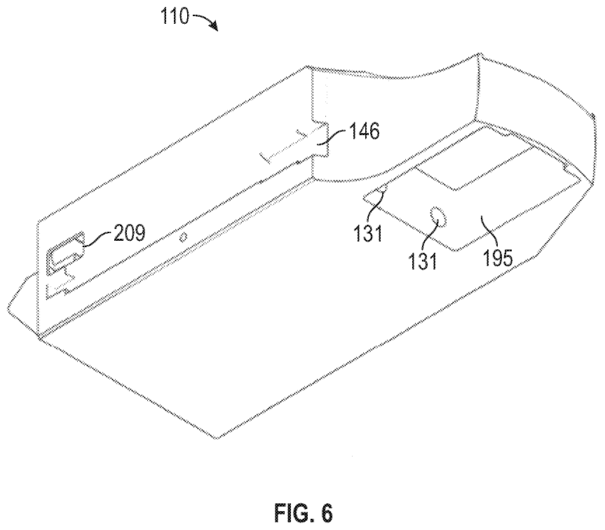

FIG. 6 shows a bottom back right view of the center body 110, which includes a dovetail slide 146, which is used to attach the left guitar body as described below. Center body 110 also includes a curved surface 195 for engaging with the neck block as described below.

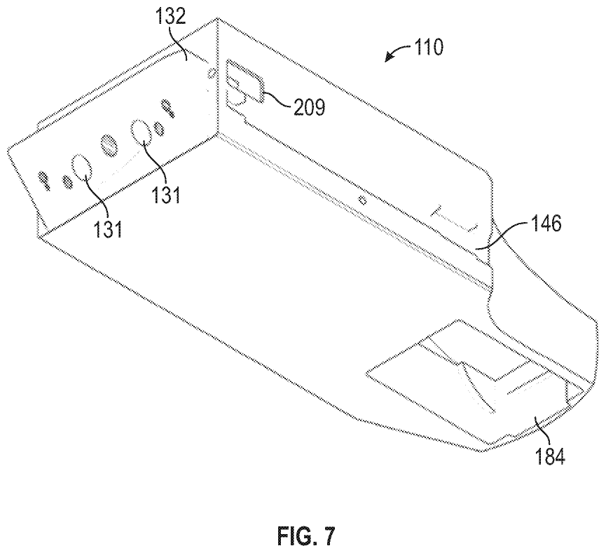

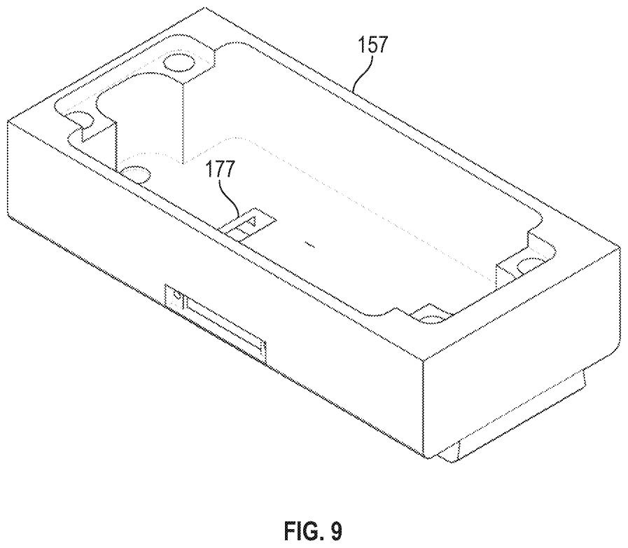

FIG. 7 shows a bottom front right view of the center body 110, which shows details of the bridge mount appendage 132. The dovetail slide 146 is also shown, which is used to attach the right guitar body, as described below. Opening 209 allows an electrical cable to pass from the pickup to the electronic module. In one embodiment, an electrical cable passes from the electronic module through slot 160. The connection at each end of the cable may be made using micro jst (Japanese solderless terminal) connectors having a holder that slides into the slot 160. Another slot 177 is provided in the bottom of the pickup carriage 157 shown in FIG. 9 to provide an alternative electrical connection option. Alternatively permanent electrical connections using solder may be used where appropriate.

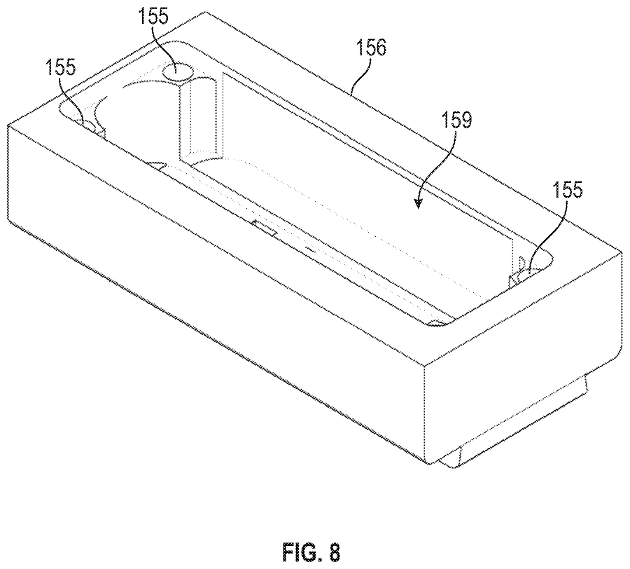

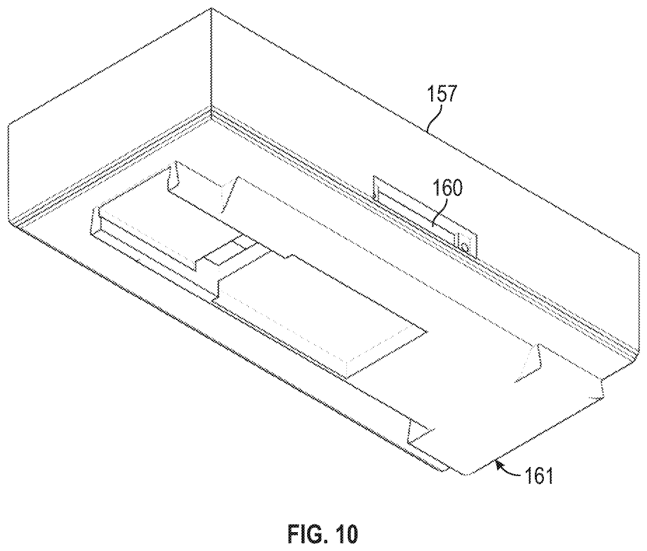

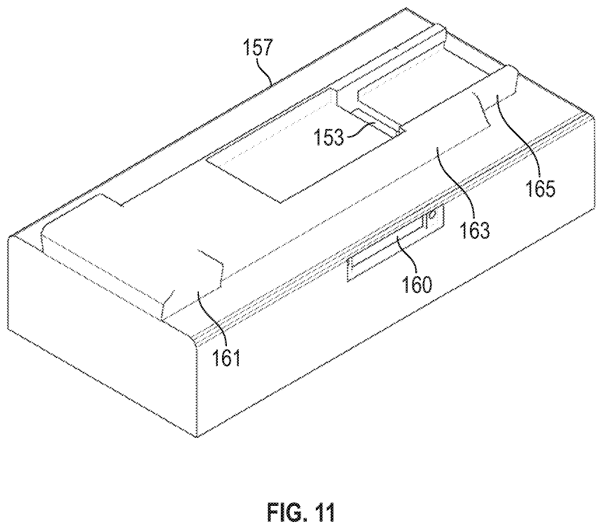

FIGS. 8-11 show the pickup carriage 156, which is designed to hold a guitar pickup (not shown) and to be slid into the slides 142 described above. In particular, FIG. 8 shows a top back left view of left view of a pickup carriage 156 configured to hold a single coil pickup. FIG. 9 shows a top back left view of a pickup carriage 157 configured to hold a dual coil (Humbucker) pickup. FIG. 10 shows a bottom back right view of a pickup carriage 157. FIG. 11 shows a bottom back left view of the pickup carriage 157, which includes a dovetail slide 159 that is configured to engage with the slides 142 shown in FIG. 3. In more tail, dovetail slide 159 includes on its left edge three portions 161, 163 and 165 having three different widths. These three regions facilitate correct alignment of the pickups and are configured to engage with three corresponding regions 167, 169 and 171 in the dovetail slides 142 in the center body 110. The pickup is attached by means of screws inserted into the holes 155 in the pickup carriage 156. An electrical cable may pass through the pickup carriage 156 through cable channel 153. In other embodiments a battery carriage 151 can be used to hold a battery instead of a pickup, but is otherwise employed to be attached in an equivalent manner as the pickup carriage 156. A slot 160 in the end of the pickup carriage enables an electrical wire to pass from the cable channel 144 to the pickup being carried by the pickup carriage 156. The pickup carriage 156 or the battery carriage 151 may be used to hold other components, such as modules for onboard effects, an air tag for tracking, or others.

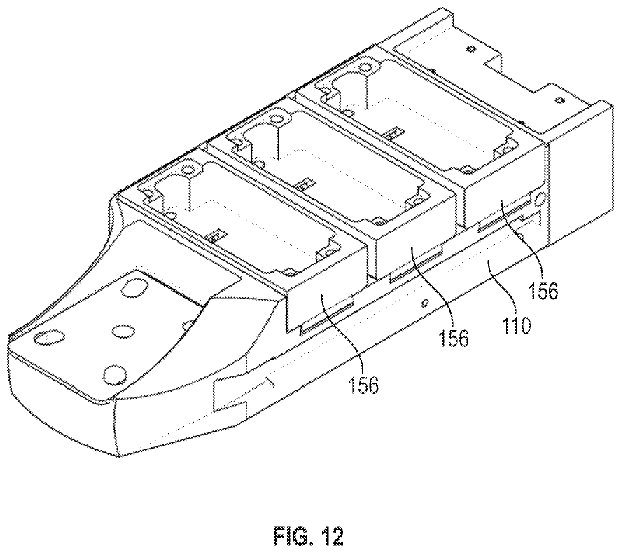

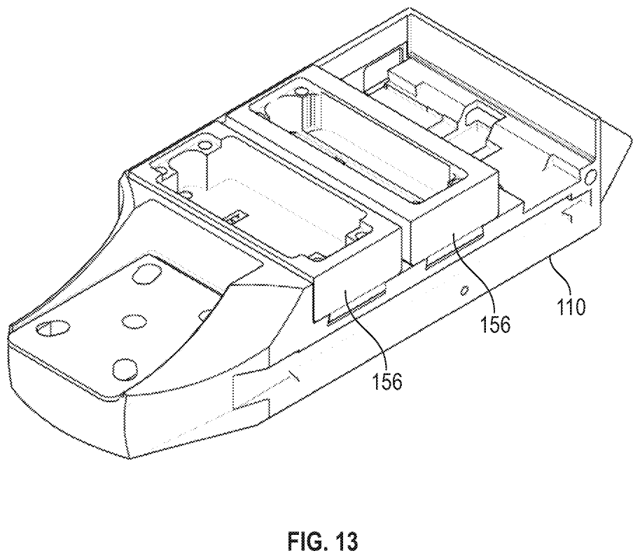

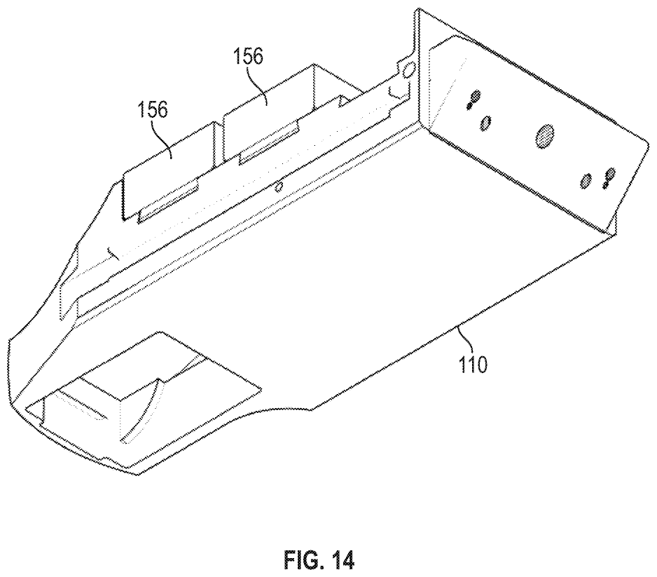

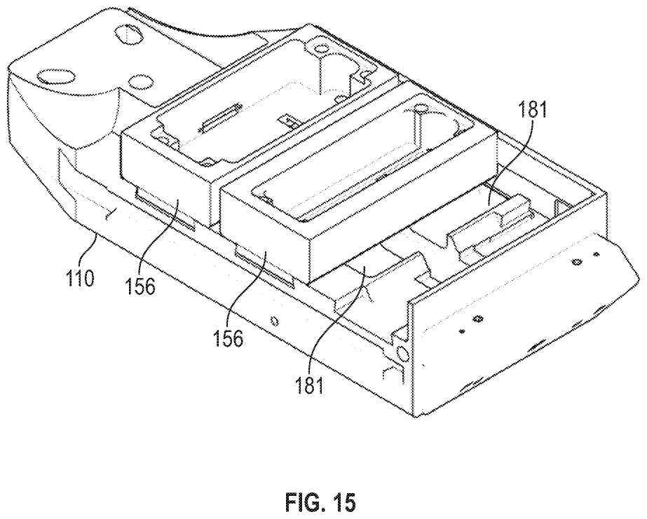

FIGS. 12-15 show the center body 110 with pickup carriages 156 installed. In particular, FIG. 12 shows a top back left view of the center body 110 with three pickup carriages 156 installed. FIG. 13 shows a top back left view of the center body 110 with two pickup carriages 156 installed. FIG. 14 shows a bottom front left view of the center body 110 with two pickup carriages 156 installed. FIG. 15 shows a top front left view of the center body 110 with two pickup carriages 156 installed. As shown in FIG. 15, the center body 110 includes curved recesses 181, which are for the purpose of allowing space to route cables or electrical components.

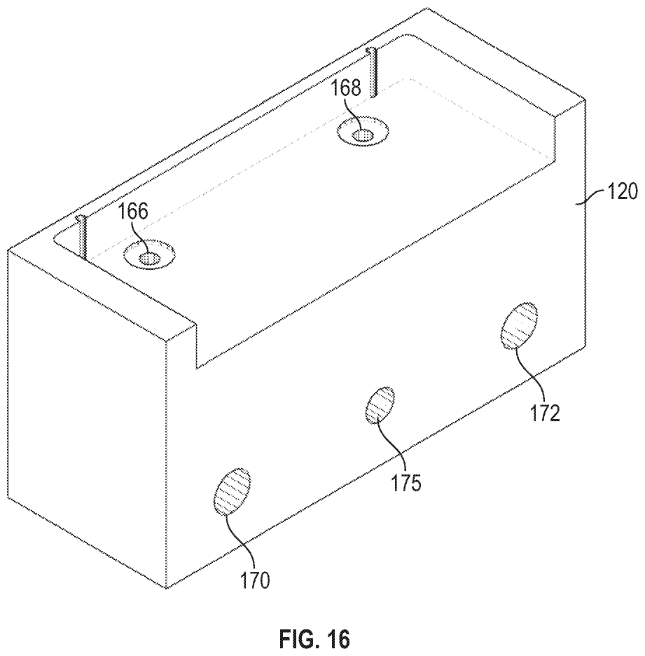

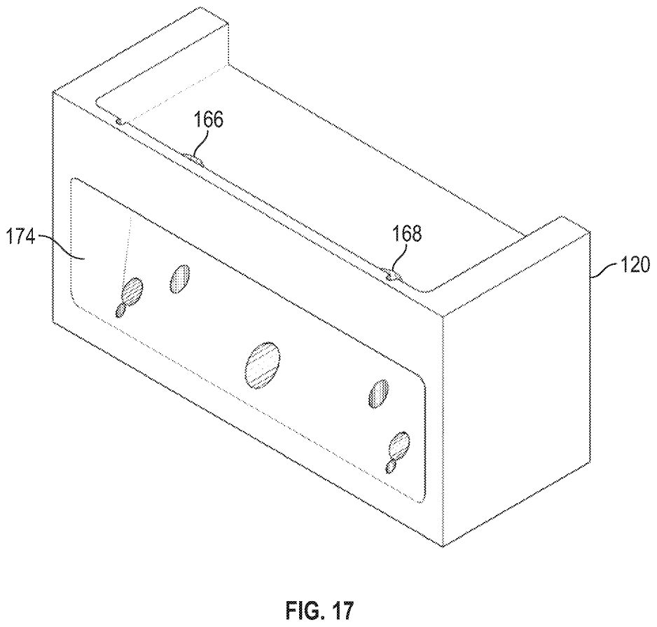

FIGS. 16 and 17 show the bridge mount 120. It will be appreciated that the exact dimensions and design of the bridge mount may be modified to accommodate various kinds of guitar bridges, such as Floyd rose or Hard Tail bridges. FIG. 16 shows a top front left view of the bridge mount 120, which allows a guitar bridge (not shown) to be easily removed from the center body 110 without detaching the bridge from the bridge mount 120. A hole 175 may be used to insert a quick release pin (not shown) that is also inserted into hole 185 in the center body, which permits the bridge mount 120 to be easily secured and removed. If a more permanent securing of the bridge mount 120 is desired two horizontal holes 170 and 172 with the same spacing as holes 173 in the center body appendage 132 permit a pair of screws to connect the bridge mount 120 with the center body appendage 132. Two vertical holes 166 and 168 are provided to connect the bridge to the bridge mount.

FIG. 17 shows an angled recess 174 that engages with the center body appendage to provide a connection that is strong and can withstand significant torsional forces exerted by the neck 132.

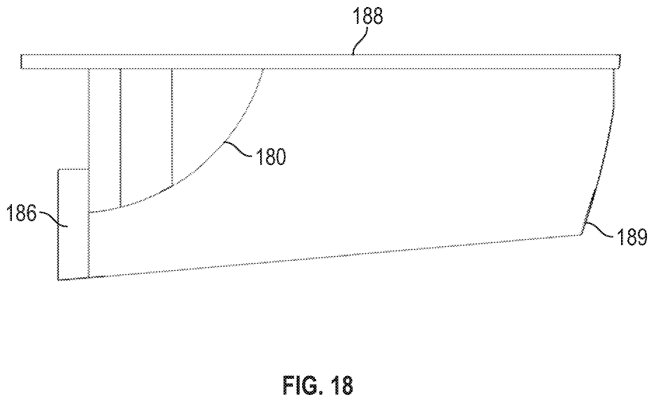

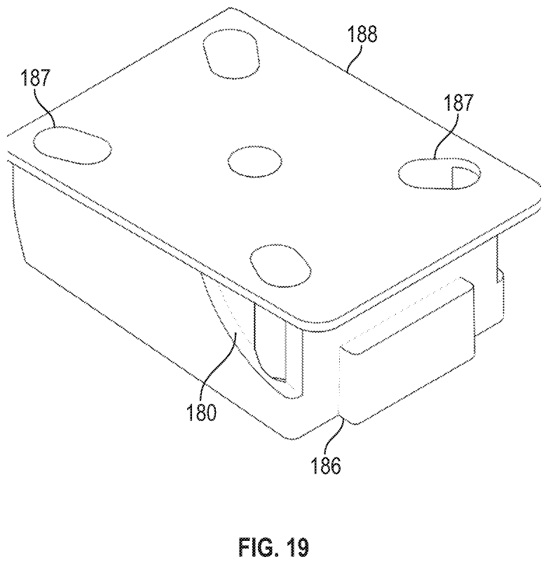

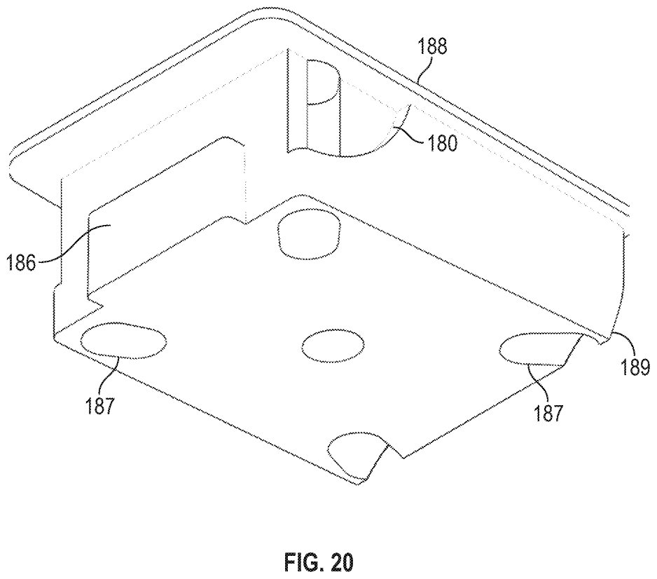

FIGS. 18-20 show various views of the neck block 188 which is configured to be installed into the neck attachment opening 128. FIG. 18 shows a left view of the neck block 188. FIG. 19 shows top back right view of the neck block 188 and FIG. 20 shows a bottom back left view of the neck block 188. A curved slide recess 180 is included on each side of the neck block 188, which is designed to engage with the curved slide 148 in the neck attachment opening 128. In addition, the neck attachment opening 128 includes a tab recess 184 which engages with tab 186 in the neck block 188 to insure correct alignment of the neck with the center body 110. Openings 187 are provided to enable a neck 112 to be bolted onto the neck block 188. Curved surface 189 is configured to match a curved surface of an adjacent curved surface 195 of the neck attachment opening 128.

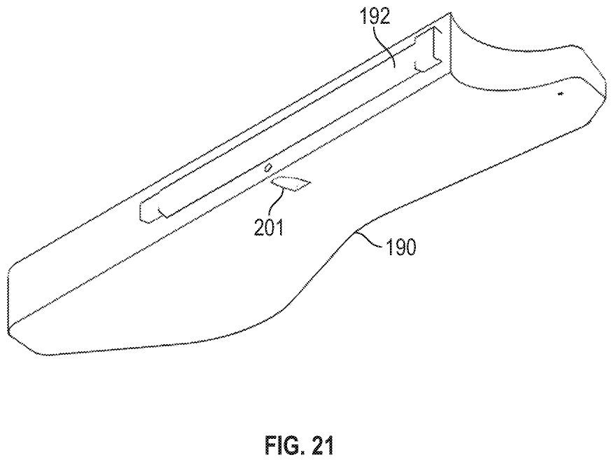

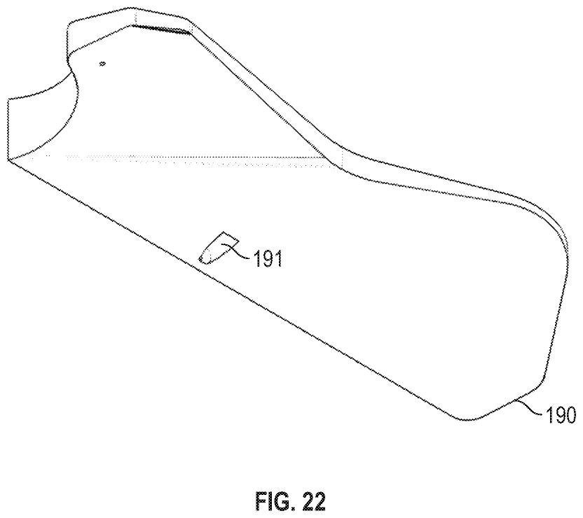

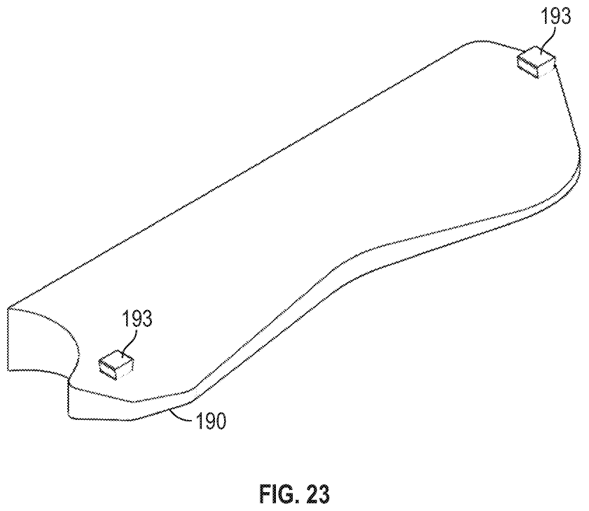

FIGS. 21-23 show various views of the left body 190. In particular, FIG. 21 shows a bottom back right view of the left body 190, which includes a projection that comprises the pin portion of a dovetail joint that engages with the tail portion 146 of the dovetail joint in the center body 110 (see FIG. 6). This dovetail joint enables the left body 190 to be easily removed from the center body 110. Also shown is opening 201 which is provided to enable the optional use of a screw (not shown) to secure the left body more permanently to the center body 110 wherein the screw enters hole 223 in the center body. FIG. 22 shows a bottom back left view of the left body 190 showing that the left body 190 also includes an opening 191 which provides for a screw be inserted into a corresponding opening in the center body 110 to further secure the left body 190 to the center body 110. FIG. 23 shows a top back left view of the let body 190 with includes a pair of pin portions 193 which enable the attachment of a cover plate 196 as described below.

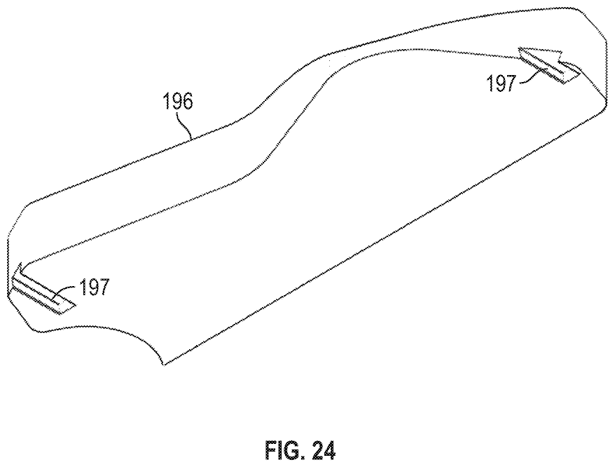

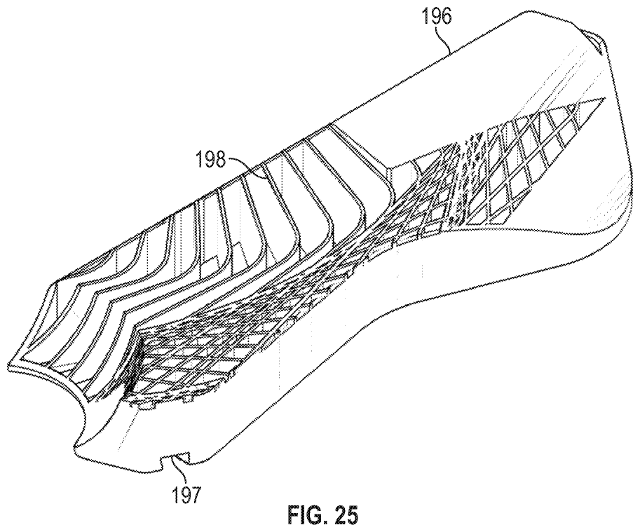

FIGS. 24-27 show the left cover plate 196. FIG. 24 shows bottom front left view of the cover plate 196, which includes dovetail slides 197 which engage with the pin portions 193 on the left body to secure the left cover plate 196 to the left body 190. FIG. 25 shows a top back left view of the cover plate 196, which shows decorative designs 198 in the cover plate. In the embodiment shown in FIG. 25, the decorative designs are created by the use of fin-like structures created using a 3D printer such as the product available from Bambu Lab Model P1. It will be appreciated that cover plate 196 may be created using many alternative designs and materials to achieve the desired esthetic appearance. It is notable that the cover plate is easily removed by sliding it laterally using by means of the dovetail slides 197 and replaced with a different cover plate 196 to quickly change the appearance of the modular guitar 100. Also, the feel of the guitar to the musician can be changed by substituting cover plates with different thickness, shapes and textures to suit the taste and mood of the musician.

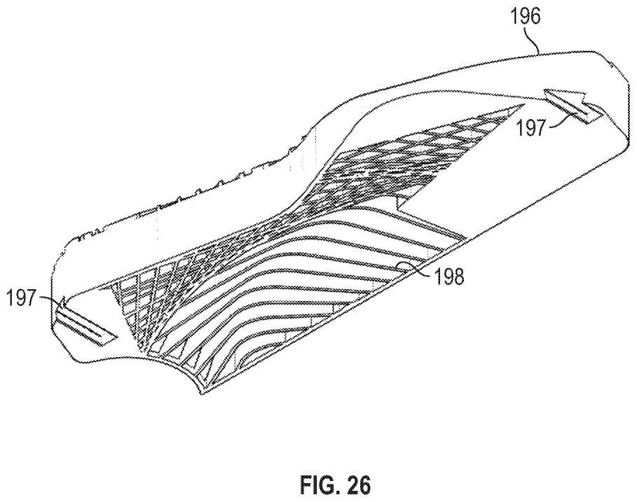

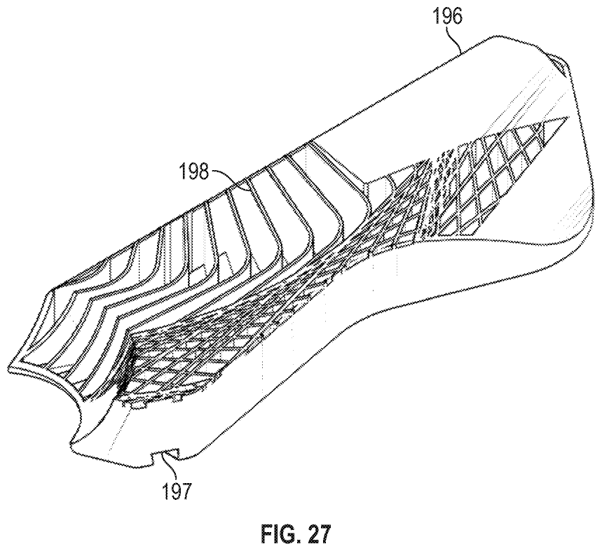

FIG. 26 shows a bottom front left view of the cover plate 196. FIG. 27 shows a top back left view of the cover plate 196.

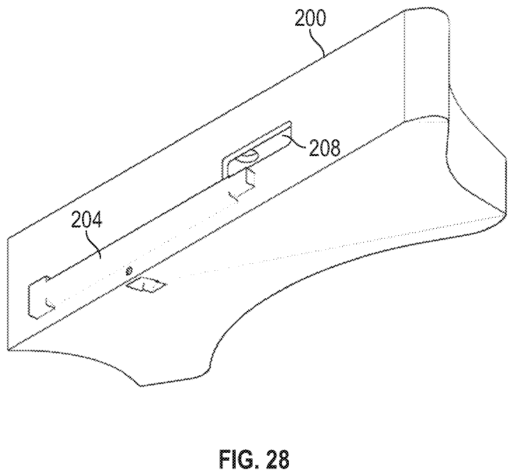

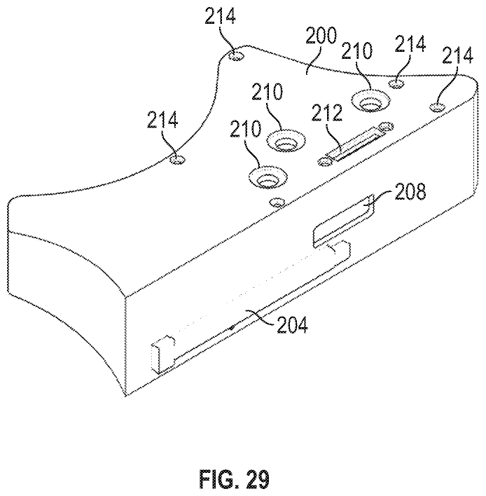

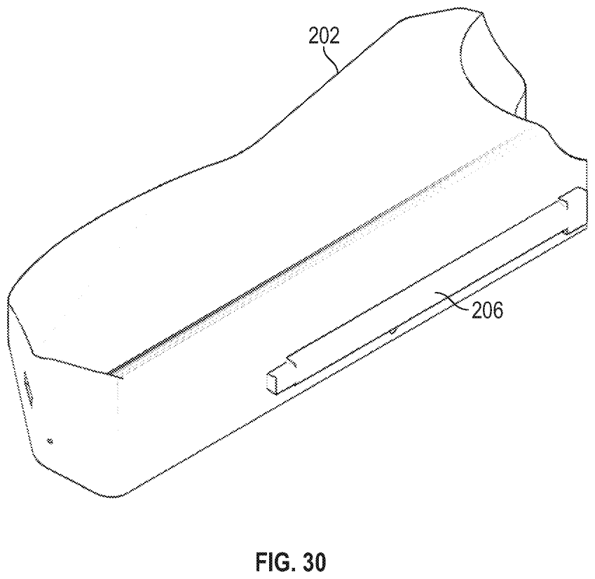

FIGS. 28-30 show an alternative embodiment of the modular guitar 100. In this embodiment a full thickness body is used instead of the combination of body and cover plate. In particular, FIG. 28 shows a bottom front left view of a full thickness right body 200. FIG. 29 shows a top back left view of the full thickness right body 200. FIG. 30 shows a top front right view of the full thickness left body 202. Also shown in FIG. 28 is a dovetail pin 204, which is configured to engage with the dovetail slide 146 in the center body 110 to attach thereto. Likewise FIG. 30 shows a dovetail pin 206, which is configured to engage with the dovetail slide 146 in the center body 110 to attach thereto. Also shown in FIGS. 28 and 29 is an opening 208, which lines up with the opening 209 in the center body 110 and with the slot 160 in the pickup carriage 157 to enable electrical cables to pass through from the pickup to the electronic module as described below.

Also shown in FIG. 29 is a series of openings 210 to permit controllers of electrical components to pass through. For example, as shown in FIG. 1 adjustment knobs 125 are attached potentiometers that are part of the electronic module (not shown) mounted inside the right body 114. Similarly, opening 212 is provided to allow an adjustment lever (not shown) to pass through to enable further adjustment of the sound of the guitar. Holes 214 are provided to permit the attachment of the top plate 127.

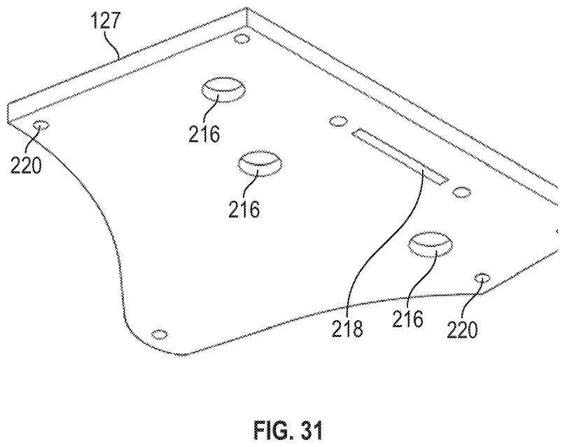

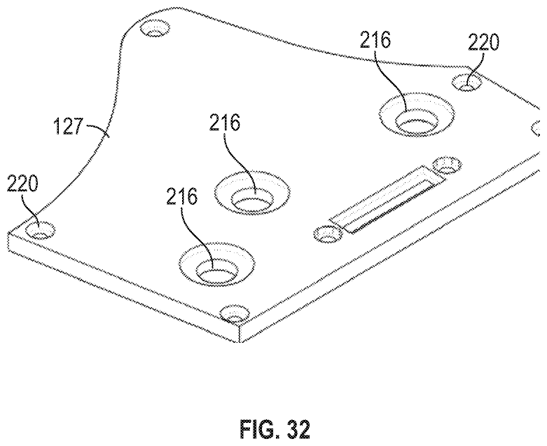

FIGS. 31-32 show details of the top plate 127, which includes openings 216 that are positioned to line up with openings 210, opening 218 that lines up with opening 212 and holes 220 that line up with holes 214.

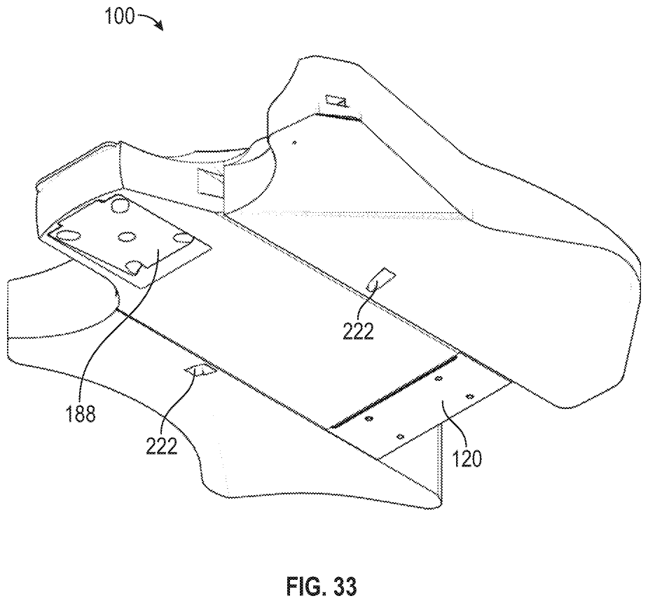

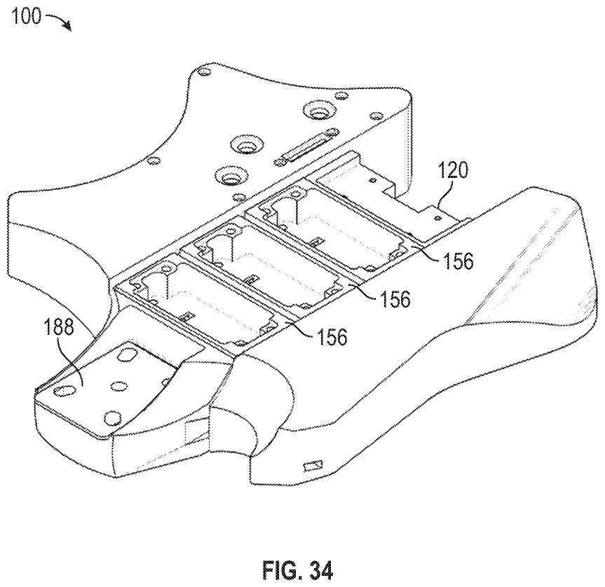

FIGS. 33-37 show embodiments of a partially assembled modular guitar 100. FIG. 33 shows a bottom back left view of the partially assembled modular guitar. The left and right body components are attached to the center body by means of the dovetail joints described above. Openings 222 are provided to enable the optional use of a screw (not shown) to secure the left and right body components more permanently to the center body wherein the screw enters hole 223 in the center body. The bridge mount 120 and the neck block 188 are shown attached to the center body 110. FIG. 34 shows a top back left view of the partially assembled modular guitar 100. In this view, three pickup carriages 156 are installed in the center body 110.

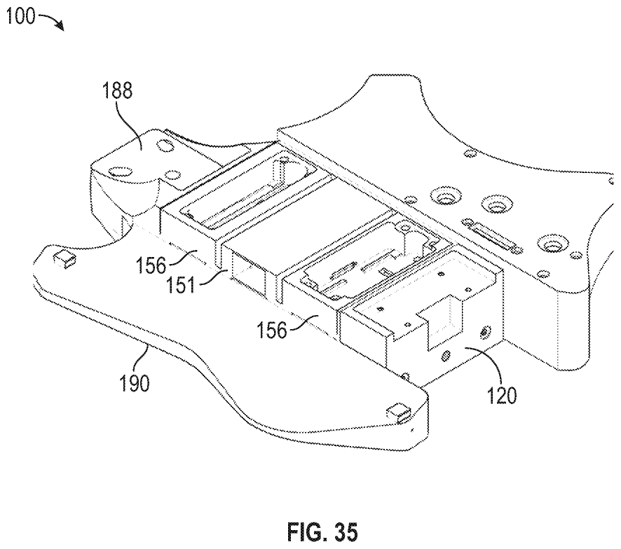

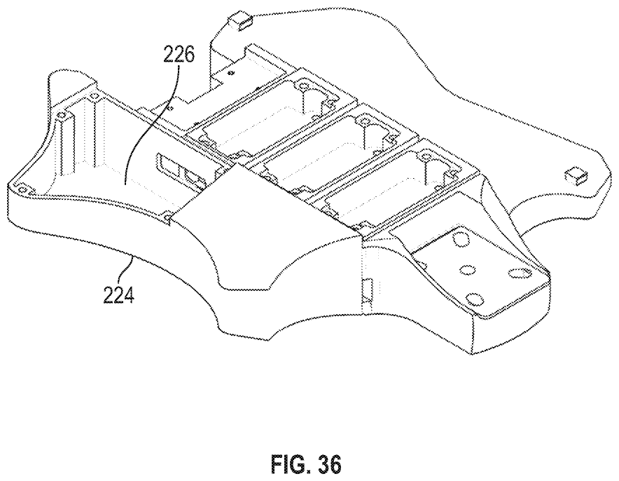

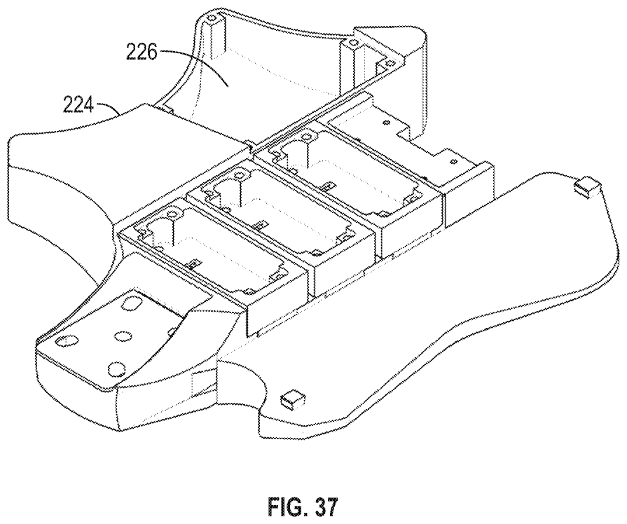

FIG. 35 shows a top front left view of the partially assembled modular guitar 100. In this view two pickup carriages 156 and a battery carriage 151 are installed. Also, in this view the left plate 196 has been removed. In this configuration, the pickup carriages can be easily removed by sliding them laterally in the direction of the space created by the removal of the left plate 196. FIGS. 36-37 show an alternative embodiment with a right body 224 including a chamber 226 configured to contain an electronic module (not shown.) Chamber 226 is covered by use of top plate 127. FIGS. 34-35 do not show the chamber 226, but could include a such a chamber if desire. In some embodiments a manufacturer may not provide a use accessible chamber and may seal the electronics module to prevent access to non-user serviceable components.

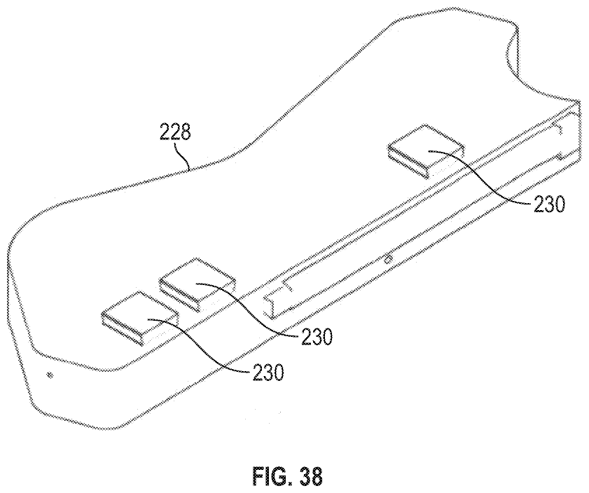

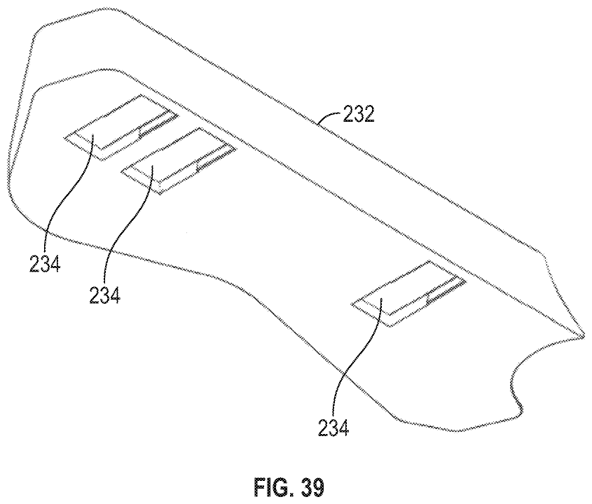

FIGS. 38-39 show an alternative embodiment of a left body 228 and left plate 232. FIG. 38 shows a top front right view of the left body 228 and FIG. 39 shows a bottom front right view of the left plate 232. Left body 228 has three tabs 230 which are configured to engage with the openings 234 in the left plate 232 by inserting and sliding laterally. This results in a sturdier and less visible connection than left plate shown in FIG. 24.

With a single center body 110, in general every other part of the modular guitar may be easily changed. The neck and bridge are designed in a way that allows for them to be removed without needing to use any tools as long as the optional quick release pin or screw are not employed. The tension of the strings alone keeps the neck and the bridge mount secured in place. In addition, the body and pickups can also be removed without the use of tools, since the screws and/or quick release pins, are optional for these components also.

In order to change the neck, one would do the following: Remove the screws (or quick release pin) holding the bridge mount to the center body. Then loosen the strings and remove the bridge. Then rotate the neck towards the back of the guitar and slide it forward. A new neck can then be installed by following the reverse of this procedure. To change the left plate 196 the left plate is slid longitudinally along the dovetail joint and a new left plate is installed using the reverse procedure. To change the left body 116, after the left plate 196 is removed the left body is removed by sliding it longitudinally along the dovetail joint. A new left body 116 may then be installed by using the reverse procedure.

To install or exchange one or more pickups 119, the left body 190 is removed from the center body 110 by sliding it along the dovetail joint 134 (after removing the locking screw from hole 201 if one is employed). The pickup carriage 156 holding the pickup 119 can be removed from the center body 110 by sliding it laterally away from the center body 110. The pickup can then be removed from the pickup carriage by removing the screws in the holes 155. A replacement pickup can then be installed in the pickup carriage 156 by following the reverse of the above procedure. A similar procedure can be used to replace a battery contained in the battery carriage 151. It is notable that an advantage of the disclosed embodiment is that pickups 119 can replaced without removing the strings and without the need to retune the guitar.

A bridge 122 can be easily replaced by removing loosening the strings 124 (removal is not required) from the bridge 122 and removing the screws in the openings 171 and 173 holding the bridge mount 120 to the center body 110. Alternatively if a quick release pin is used, the quick release pin is removed instead of these screws. In an alternative embodiment, neither the screws nor a quick release pin is used; the bridge and neck are held in place by the tension of the strings alone. The old bridge can then be removed from the bridge mount 120 by removing screws in the holes 166 and 168. A new bridge 122 can then be installed in the bridge mount 120 and bridge mount and strings reinstalled by using the reverse of the above procedure.

The modular guitar 100 may be constructed using the disclosed embodiments in a variety of ways. It may be constructed as an electric or as an acoustic guitar with appropriate modifications. For example, an acoustic version of the modular guitar would be modified from the above embodiments but the basic components would be similar. For example, the dimensions would need to be changed to allow for larger pickup carriages to accommodate the acoustic sound hole. It may be necessary to have a pickup carriage that takes up more than one slot. The user could employ a variety of different combinations of various kinds of woods, materials, inlays, and shapes for users to mix and match to achieve specific tones and visual styles. Also, the cutouts for the pickup connectors may not be need and the cavity for the electronics module may not be needed.

Also, other embodiments may incorporate features disclosed herein into stringed instruments besides guitars. In addition, a variety of materials may be used to construct the modular guitar 100. Most of the components described above may be constructed using a 3D printer such as the product available from Bambu Lab Model P1S described above. Also, many of the components described herein may be constructed using materials conventionally used for guitars as well as alternative materials such as metal and resin. The modular nature of the guitar makes it easy to employ varied materials for different components. The use of varied materials enables the user to achieve distinctive characteristics such as weight, tuning stability, style, etc. Also, the modular nature of the guitar isolates these components to allow for different accessories to be easily integrated into the guitar. Such accessories include, but are not limited to batteries in the pickup carrier, and assorted styles of bridges. In addition, the modular design allows for other unconventional additions such as a pickup holder built into the body, or electronics for controlling things other than the guitar itself, such as pedal board, lights, etc.

It is understood that the various embodiments of the present invention may be implemented individually, or collectively, in modular guitars, or other stringed instruments using various combinations of the embodiments disclosed herein. The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

What is claimed is:

1. A modular stringed musical instrument comprising:
center body having front face with at least one pickup cavity disposed therein;
a bridge attached to the center body;
neck connected at a first end to the center body and having a head at a second end;
a plurality of strings, each string being attached to the head at one end to the bridge at the other end; and
an electronic pickup carriage removably attached to the body unit and configured to fit into the pickup cavity, wherein the body unit face is configured to enable the pickup unit to slide laterally in a motion parallel to the body unit front face when removing the electronic pickup unit from the body unit.

2. The stringed instrument according to claim 1 wherein the pickup cavity comprises:
a planar bottom;
three vertically walls disposed orthogonal to the planar bottom, with no fourth side, wherein a fourth side of the pickup cavity is open;
grooves in two opposing vertical walls;
a groove in the planar bottom.

3. The stringed instrument according to claim 2 further comprising a pickup carriage having a cavity for containing an electronic pickup and pins along first and second sides configured to engage with the grooves in the electronic pickup cavity.

4. The stringed instrument according to claim 3 wherein the stringed instrument is a guitar.

5. The stringed instrument according to claim 1 wherein the stringed instrument is an electric guitar.

6. The stringed instrument according to claim 1 wherein the stringed instrument is an acoustic guitar.

7. A modular stringed musical instrument comprising:
center body having front face with at least one pickup cavity disposed therein;
a bridge attached to the center body;
neck connected at a first end to the center body and having a head at a second end;
a plurality of strings, each string being attached to the head at one end to the bridge at the other end;
a bridge mount removably attached to the center body, wherein and the bridge is attached to the bridge mount using fasteners;
an angled appendage protruding from the center body where it meets the bridge mount;
the bridge mount having an angled cavity configured to receive the angled appendage in the center body, wherein the tension of the strings pulls the bridge mount to the center body such that when the strings are loosened, the bridge mount can be removed, whereby fasteners attaching the bridge mount to the center body are not necessary.

8. The modular stringed instrument according to claim 7 further comprising:
the center body having a neck cavity with at least one recess with a curved surface;
the neck first end having a curved ridge configured to slide along the curved surface of the neck cavity when the first end of the neck is engaged in the neck cavity such that the center of curvatures of the neck curved surface and the curved surface of the neck cavity approximately coincide.

9. The modular stringed instrument according to claim 8 wherein the neck can be attached to the center body by partially inserting the first end of the neck into the neck cavity and rotating the neck about the center of curvature until the neck is fully engaged with the center body, wherein when the strings are tightened the tension of the strings pulls the neck towards the center body such and wherein when the strings are loosened, the neck can be removed from the center body, whereby fasteners attaching the neck to the center body are not necessary.

10. A method of reconfiguring a stringed instrument comprising:
removing a body side of the stringed instrument by sliding it in a motion parallel to the longitudinal axis of the stringed instrument to separate it from a center body of the stringed instrument;
removing a pickup carriage containing a first electronic pickup from the stringed instrument by sliding the pickup carriage in a motion perpendicular to the longitudinal axis of the stringed instrument to disengage it from a center body of the stringed instrument; and
installing a pickup carriage having a second electronic pickup by sliding the pickup carriage in a motion perpendicular to the longitudinal axis of the stringed instrument causing it to engage with a portion of the center body of the stringed instrument.

11. A method of reconfiguring a stringed instrument comprising:
loosening the strings of the stringed instrument;
lifting a bridge mount away from a center body of the stringed instrument to disengage the bridge mount from the center body;
replacing the bridge in the bridge mount with a different bridge;
installing the bridge mount by pushing it downward and causing it to reengage with the center body of the stringed instrument; and
retightening the strings.

12. A method of reconfiguring a stringed instrument comprising:
loosening the strings of the stringed instrument;
lifting a neck of the stringed instrument to rotate it in its engagement with a center body of the stringed instrument and lifting it out of an opening in the center body causing the neck to disengage with the center body;
installing the strings on a new neck;
installing the new neck by inserting one end of the neck into the opening in the center boy and rotating the neck to fully engage with the center body; and
retightening the strings.
